(19) United States
(12) Patent Application Publication
(10) Pub. No.: US 2026/0359744 A1
(43) Pub. Date: Nov. 12, 2026

(54) SYSTEM AND METHOD FOR TALENT LIFECYCLE MANAGEMENT

(71) Applicant: AidenAi, Inc, Princeton, NJ (US)

(72) Inventor: Srinivas Kamadi, Princeton, NJ (US)

(21) Appl. No.: 19/669,110

(22) Filed: May 6, 2026

Related U.S. Application Data
(60) Provisional application No. 63/801,416, filed on May 7, 2025.

(51) Int. Cl. G06Q 10/0631; G06Q 10/1053

(52) U.S. Cl. CPC G06Q 10/063112; G06Q 10/1053

(57) ABSTRACT

A method for talent lifecycle management is disclosed. The method includes receiving a workforce demand signal and translating the workforce demand signal into a requisition data structure. The method includes obtaining a plurality of canonical candidate documents based on ingesting a plurality of candidate records from a plurality of sourcing channels. The method includes generating a ranked candidate list based on the plurality of canonical candidate documents and the requisition data structure. The method includes generating an assessment outcome data structure by performing an assessment of a candidate from the ranked candidate list. The method includes routing the assessment outcome data structure for workflow orchestration and coordinating an interview session with the candidate. The method includes generating an updated candidate ranking based on the multi-dimensional match score, the assessment outcome data structure, and the consolidated feedback data structure and activating a subsequent workflow stage.

### FIELD OF INVENTION

The present disclosure generally relates to the field of computer-implemented human-capital management systems and, more particularly, to a system and method for end-to-end talent lifecycle management driven by an agentic artificial intelligence (AI) engine.

### BACKGROUND

Talent lifecycle management encompasses a totality of processes by which an organization plans for, attracts, evaluates, selects, hires, onboards, develops, and retains its human workforce. The totality of processes includes workforce demand planning, requisition creation, sourcing, resume parsing, screening, skill assessment, interview coordination, offer generation, onboarding, performance management, learning and development, succession planning, and off-boarding. A cumulative effectiveness of these processes directly governs an organization's productivity, innovation capacity, customer responsiveness, regulatory compliance posture, and overall competitive standing.

Conventional approaches address these processes only in isolated fragments. Professional networking platforms maintain large databases of professional profiles and provide search capabilities for identifying candidates, however operate principally as outreach databases. Applicant Tracking Systems (ATS) capture applications, store candidate data, and track individuals through defined recruitment stages, but the ATS typically lack agentic automation, dynamic form generation, demand-side orchestration, or learning recommendation. Dedicated platforms for students and early-career professionals facilitate internship and entry-level matching but do not extend across an entire lifecycle. Assessment platforms perform candidate evaluation in a stand-alone fashion, with results that must be manually transcribed back into recruitment workflows. Job boards and posting websites collect applications but do not screen, assess, interview, or onboard.

A fragmentation between these conventional point solutions creates a number of technical and operational deficiencies, including, without limitation, disconnected workflows that compel duplicate data entry, lossy transitions between sourcing, screening, assessment, hiring, and onboarding stages, and data inconsistency across platforms. Such fragmentation further results in heavy manual effort by recruiters for routine activities such as resume screening, scheduling, follow-up communication, and document collection, leading to extended time-to-fill and elevated cost-per-hire. Additionally, existing systems rely on rigid, hard-coded workflow templates that do not adapt to industry-specific, geography-specific, or role-specific compliance and process variations, and exhibit an absence of any computational coupling between business demand planning and talent acquisition, resulting in misalignment between organizational goals and workforce composition. These systems also provide limited or no autonomous decision support for next-best actions, explainable recommendations, or predictive headcount planning.

Further deficiencies include a lack of unified, role-personalized interfaces, which forces every persona, including student, job seeker, recruiter, vendor, employer, hiring manager, and administrator, to navigate the same generic screens. Limited or absent voice-driven and text-driven assistive interfaces create accessibility barriers and increase onboarding friction. Integrations with surrounding enterprise systems, including Applicant Tracking Systems (ATS), Enterprise Resource Planning (ERP) systems, Customer Relationship Management (CRM) platforms, Learning Management Systems (LMS), video platforms, and payroll systems, are typically brittle and implemented as one-off connectors that fail under schema changes. Existing platforms further exhibit inadequate skill-gap analysis and an absence of personalised learning paths, such that candidates who narrowly miss a role are simply rejected rather than developed. Additionally, vendor and sourcing-agency campaign management is frequently performed outside a core platform, with no unified visibility into campaign-level conversion metrics.

Therefore, improved systems and methods for talent lifecycle management that address these shortcomings are desired.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

One aspect of the present disclosure is a method for talent lifecycle management is disclosed. The method includes receiving a workforce demand signal. The workforce demand signal indicates a talent requirement comprising a skill set specification and a timeline. The method includes translating the workforce demand signal into a requisition data structure. The requisition data structure being associated with the skill set specification and the timeline. The method includes obtaining a plurality of canonical candidate documents based on ingesting a plurality of candidate records from a plurality of sourcing channels. The method includes generating a ranked candidate list based on the plurality of canonical candidate documents and the requisition data structure. The generating produces a multi-dimensional match score, an evidence data structure, and a gap data structure for each candidate in the ranked candidate list. The method includes generating an assessment outcome data structure by performing an assessment of a candidate from the ranked candidate list. The method includes routing the assessment outcome data structure for workflow orchestration. The routing triggers a stage transition based on a dual-trigger evaluation, the dual-trigger evaluation comprising a role-based trigger condition and an event-based trigger condition. The method includes coordinating an interview session with the candidate. The coordinating comprises conducting an artificial-intelligence-based interview and generating a consolidated feedback data structure based on the interview session. The method includes generating an updated candidate ranking based on the multi-dimensional match score, the assessment outcome data structure, and the consolidated feedback data structure. The updated candidate ranking is associated with the evidence data structure and the gap data structure. Further, the method includes activating a subsequent workflow stage based on the updated candidate ranking. The subsequent workflow stage is determined by the dual-trigger evaluation.

Another aspect of the present disclosure is a system for talent lifecycle management is disclosed. The system includes a processor, a memory storing instructions that, when executed by the processor, cause the processor to receive a workforce demand signal. The workforce demand signal indicates a talent requirement comprising a skill set specification and a timeline. The processor is configured to translate the workforce demand signal into a requisition data structure. The requisition data structure being associated with the skill set specification and the timeline. The processor is configured to obtain a plurality of canonical candidate documents based on ingesting a plurality of candidate records from a plurality of sourcing channels. The processor is configured to generate a ranked candidate list based on the plurality of canonical candidate documents and the requisition data structure. The generating produces a multi-dimensional match score, an evidence data structure, and a gap data structure for each candidate in the ranked candidate list. The processor is configured to generate an assessment outcome data structure by performing an assessment of a candidate from the ranked candidate list. The processor is configured to route the assessment outcome data structure for workflow orchestration. The routing triggers a stage transition based on a dual-trigger evaluation. The dual-trigger evaluation comprising a role-based trigger condition and an event-based trigger condition. The processor is configured to coordinate an interview session with the candidate. The coordinating comprises conducting an artificial-intelligence-based interview and generating a consolidated feedback data structure based on the interview session. Further, the processor is configured to generate an updated candidate ranking based on the multi-dimensional match score, the assessment outcome data structure, and the consolidated feedback data structure. The updated candidate ranking is associated with the evidence data structure and the gap data structure. The processor is configured to activate a subsequent workflow stage based on the updated candidate ranking. The subsequent workflow stage is determined by the dual-trigger evaluation.

Yet another aspect of the present disclosure is a non-transitory computer-readable medium storing instructions that, when executed by a processor, cause the processor to: receive a workforce demand signal. The workforce demand signal indicates a talent requirement comprising a skill set specification and a timeline. The processor is configured to translate the workforce demand signal into a requisition data structure. The requisition data structure being associated with the skill set specification and the timeline. The processor is configured to obtain a plurality of canonical candidate documents based on ingesting a plurality of candidate records from a plurality of sourcing channels. The processor is configured to generate a ranked candidate list based on the plurality of canonical candidate documents and the requisition data structure. The generating produces a multi-dimensional match score, an evidence data structure, and a gap data structure for each candidate in the ranked candidate list. The processor is configured to generate an assessment outcome data structure by performing an assessment of a candidate from the ranked candidate list. The processor is configured to route the assessment outcome data structure for workflow orchestration. The routing triggers a stage transition based on a dual-trigger evaluation. The dual-trigger evaluation comprising a role-based trigger condition and an event-based trigger condition. The processor is configured to coordinate an interview session with the candidate. The coordinating comprises conducting an artificial-intelligence-based interview and generating a consolidated feedback data structure based on the interview session. Further, the processor is configured to generate an updated candidate ranking based on the multi-dimensional match score, the assessment outcome data structure, and the consolidated feedback data structure. The updated candidate ranking is associated with the evidence data structure and the gap data structure. The processor is configured to activate a subsequent workflow stage based on the updated candidate ranking. The subsequent workflow stage is determined by the dual-trigger evaluation.

To further clarify the advantages and features of the methods, systems, and apparatuses, a more particular description of the methods, systems, and apparatuses will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF FIGURES

This summary is provided to introduce a selection of concepts in a simplified format that are further described in the detailed description of the disclosure. This summary is not intended to identify key or essential inventive concepts of the disclosure, nor is it intended for determining the scope of the disclosure.

FIG. 1 illustrates a block diagram depicting an environment for talent lifecycle management, in accordance with an embodiment of the present disclosure;

FIG. 2 illustrates a block diagram of components of the system, in accordance with an embodiment of the present disclosure;

FIG. 3 illustrates a block diagram of components of modules of FIG. 2, in accordance with an embodiment of the present disclosure;

FIG. 4A-4B illustrate a flowchart depicting an exemplary operation of the system, in accordance with an embodiment of the present disclosure; and

FIG. 5A-5B illustrate a flowchart of a method for talent lifecycle management, in accordance with an embodiment of the present disclosure.

Further, skilled artisans will appreciate that elements in the drawings are illustrated for simplicity and may not have necessarily been drawn to scale. Furthermore, in terms of a construction of a device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more…” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises... a” does not, without more constraints, preclude the existence of other devices or other sub-systems or other elements or other structures or other components or additional devices or additional sub-systems or additional elements or additional structures or additional components.

It is an object of the present invention is to provide a system and a method for talent lifecycle management which obviates one or more of the limitations of the prior art noted above.

Another object of the present invention is to provide a system that orchestrates a plurality of modular, specialized artificial intelligence (AI) agents through a unified agentic AI engine to autonomously perform discrete recruitment, development, and retention tasks across the full talent lifecycle.

Another object of the present invention is to provide a no‑code visual agent builder having a drag‑and‑drop interface that enables non‑technical users to compose, configure, and modify AI agents, workflows, conditions, and integrations without writing code.

A further object of the present invention is to provide a workflow engine supporting configurable pipelines, role‑based and event‑based triggers, document handling, approval flows, and visibility control across the entire talent lifecycle.

A further object of the present invention is to provide a multi‑modal text‑and‑voice copilot that delivers context‑aware step‑by‑step guidance to candidates, recruiters, and vendors, and that invokes workflow and AI‑agent actions through conversational interfaces.

A further object of the present invention is to provide an integrated career‑oriented testing lab that hosts skill, behavioural, and code‑simulation assessments, and that automatically routes assessment outcomes to appropriate AI agents to drive workflow progression.

A further object of the present invention is to provide a vendor campaign management module that permits sourcing agencies and internal teams to launch, monitor, and optimize hiring campaigns within the same platform, with shared analytics.

A further object of the present invention is to provide a learning recommendation engine that performs skill‑gap analysis between candidate profiles and role requirements, and that suggests personalized learning paths, certifications, and curated content.

A further object of the present invention is to provide a demand‑to‑acquisition orchestration layer that translates business‑unit workforce requests into automated sourcing, upskilling, and internal‑mobility actions, including predictive headcount planning.

A further object of the present invention is to provide a persona‑adaptive user interface that renders role‑specific views, dynamic forms, permissions, and recommendations for each user persona including students, job seekers, recruiters, vendors, employers, and administrators.

A further object of the present invention is to provide an integration gateway enabling real‑time and batch interoperation with Applicant Tracking Systems (ATS), Enterprise Resource Planning (ERP) systems, Customer Relationship Management (CRM) platforms, Human Resource Management Systems (HRMS), Learning Management Systems (LMS), and video platforms via OAuth, application programming interface (API) keys, webhooks, and flat‑file transfer.

A further object of the present invention is to provide explainable autonomous recommendations and data‑driven analytics with confidence scores, predictive headcount forecasts, and bottleneck identification.

Embodiments of the present disclosure will be described below in detail with reference to the accompanying drawings.

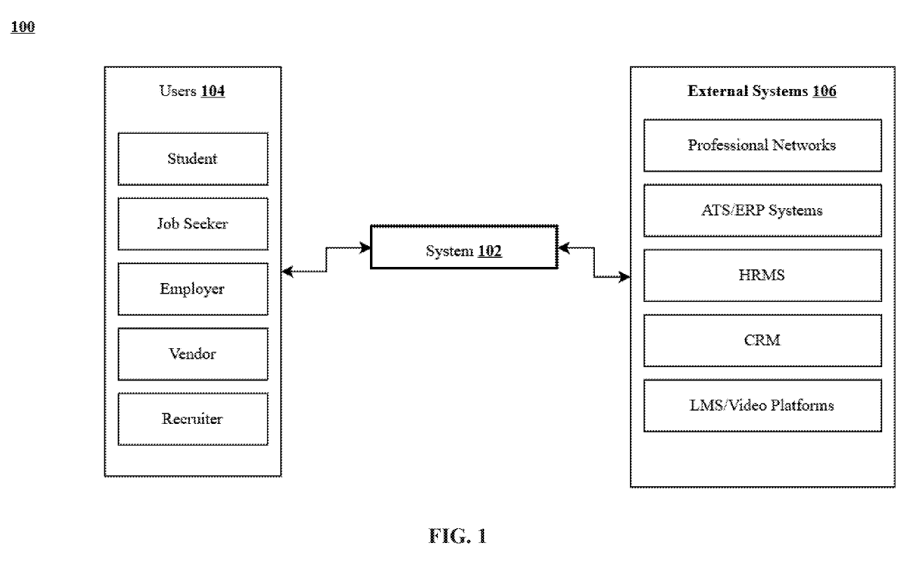

FIG. 1 illustrates a block diagram depicting an environment 100 for talent lifecycle management, in accordance with an embodiment of the present disclosure. The environment 100 includes the system 102 communicatively coupled with a plurality of users 104 (alternately may be referred hereinafter as users 104) and one or more external systems 106 over a communication network (not shown). The system 102 is configured to act as a centralized orchestration platform that manages interactions, data exchange, and workflow execution across the talent lifecycle.

In an embodiment, the plurality of users 104 represents different user personas that interact with the system 102 through respective user interfaces. As illustrated, the users 104 may include, without limitation, a student, a job seeker, an employer, a vendor, and a recruiter. Each user persona may have role‑specific permissions, views, and interaction flows enabling the system 102 to provide tailored functionality corresponding to the respective role. For example, students and job seekers may interact with the system 102 for profile creation, assessments, interviews, and learning activities, while recruiters, employers, and vendors may interact with the system 102 for requisition creation, candidate evaluation, workflow management, and campaign execution.

In an embodiment, the system 102 is further communicatively coupled with one or more external systems 106 to enable integration and data exchange with surrounding enterprise and third‑party platforms. As shown in FIG. 1, the external systems 106 may include professional networks, ATS and ERP systems, HRMS, CRM platforms, and LMS and/or video platforms. These external systems 106 may provide candidate data, workforce data, learning content, interview infrastructure, payroll information, or related enterprise signals to the system 102, and may receive processed outputs, workflow updates, and analytics from the system 102.

In an embodiment, the bidirectional communication links between the system 102, the users 104, and the external systems 106 enable the system 102 to ingest data from multiple sources, perform intelligent processing and orchestration, and deliver outputs such as ranked candidate lists, assessments, recommendations, workflow transitions, and notifications. It will be understood that the components illustrated in FIG. 1 are exemplary, and that the environment 100 may include additional or fewer components, or alternative configurations, without departing from the scope of the present disclosure.

In an embodiment, the system 102 may be deployed on one or more server computers, virtual machines, or containerized compute instances accessible by client devices including, without limitation, desktop computers, laptops, tablets, smartphones, kiosks, and conversational endpoints (such as smart speakers and integrated voice assistants). A communication between the system 102 and the client devices may be effected over Hypertext Transfer Protocol Secure (HTTPS), WebSocket, Real-Time Communication (WebRTC), or any equivalent protocol, optionally fortified by Transport Layer Security (TLS) 1.2 or higher.

In an embodiment, the system 102 may be implemented as a multi-tenant, cloud-deployable software platform. In another implementation, the system 102 may be deployed on one or more server computers. In another implementation, the system 102 may be deployed on virtual machines. In another implementation, the system 102 may be deployed on containerized compute instances accessible by client devices.

In an embodiment, the system 102 may be configured to receive a workforce demand signal. The workforce demand signal indicates a talent requirement comprising a skill set specification and a timeline. For example, a business unit may submit a demand for “4 Senior Backend Engineers, Bengaluru, target onboarding Jul. 01, 2026, skills: Java, Microservices, AWS”.

In an embodiment, the system 102 may be configured to translate the workforce demand signal into a requisition data structure. The requisition data structure is associated with the skill set specification and the timeline. For example, the system automatically creates open requisitions with an appropriate workflow blueprint.

In an embodiment, the system 102 may be configured to obtain a plurality of canonical candidate documents based on ingesting a plurality of candidate records from a plurality of sourcing channels. For example, a multi-source talent aggregation employs a normalization pipeline that ingests candidate records from job boards, vendor submissions, internal referrals, alumni databases, professional networks, career-fair scans, and bring-your-own files, and produces a single canonical candidate document per individual. The normalization pipeline includes (i) a schema mapping per source, (ii) a deterministic and probabilistic deduplication keyed on email, phone hashes, and name-plus-DOB, (iii) a record-merge with conflict-resolution rules, and (iv) a continuous profile update upon receipt of newer signals.

In an embodiment, the system 102 may be configured to generate a ranked candidate list based on the plurality of canonical candidate documents and the requisition data structure. The generating produces a multi-dimensional match score, an evidence data structure, and a gap data structure for each candidate in the ranked candidate list. For example, the system 102 may operate in three stages: (i) parsing, (ii) embedding and retrieval, and (iii) scoring and explanation. In a parsing stage, structured fields are extracted from a free-form resume document including, without limitation, education, employment history with dates and titles, certifications, projects, skills with proficiency indicators, geographic mobility, salary expectations, and notice period. In an embedding stage, a parsed profile is encoded into a high-dimensional vector representation using a transformer-based encoder, and a requisition is similarly encoded. In a scoring stage, multiple dimensions of similarity (skills, experience level, domain, geography, compensation feasibility, and culture cues) are combined into an overall match score. The system 102 may then emit an evidence list of resume passages that justify each dimensional score, and a gaps list of missing requirements, enabling explainability.

In an embodiment, the system 102 may be configured to generate an assessment outcome data structure by performing an assessment of a candidate from the ranked candidate list. For example, the system 102 may be configured to conduct a talent evaluation process. The talent evaluation process includes hosting and evaluating skill, behavioural, and code-simulation assessments. The system 102 may support various assessment types including, without limitation: (i) code-simulation exercises with sandboxed execution environments for technical roles; (ii) domain-based quizzes (multiple-choice, multi-select, drag-and-drop, ordered-sequence, free-text) for knowledge verification; (iii) personality-and-fit instruments (e.g., Big Five / OCEAN-aligned, situational judgment) for cultural alignment; (iv) language and communication assessments with audio capture; and (v) integrated video-response prompts with synchronized prosody and content scoring.

In an embodiment, the system 102 may be configured to route the assessment outcome data structure for workflow orchestration. The routing triggers a stage transition based on a dual-trigger evaluation. The dual-trigger evaluation comprises a role-based trigger condition and an event-based trigger condition. For example, the system 102 may evaluate dual triggers: (a) role-based triggers, which fire when an actor of a specified role performs a defined action (e.g., when a Hiring Manager approves a shortlist); and (b) event-based triggers, which fire on platform events (e.g., when an assessment score crosses a threshold, when a candidate fails to respond within a time window, or when a webhook is received from an external ATS). A combination of the role-based triggers and the event-based triggers permits expressive workflow logic without code.

In an embodiment, the system 102 may be configured to coordinate an interview session with a candidate. The coordinating comprises conducting an artificial-intelligence-based interview and generating a consolidated feedback data structure based on the interview session. For example, the system 102 may be configured to schedule, facilitate, or conduct AI-led interviews with auto-evaluation and feedback consolidation. The system 102 may support four interview modalities: (a) text-chat structured interviews, (b) voice interviews, (c) video interviews with synchronized facial-cue analysis, and (d) code-pair interviews.

In an embodiment, the system 102 may be configured to generate an updated candidate ranking based on the multi-dimensional match score, the assessment outcome data structure, and the consolidated feedback data structure. The updated candidate ranking is associated with the evidence data structure and the gap data structure. For example, candidate rankings are generated based on combined assessment and interview scores, and hiring teams review feedback through a user interface.

In an embodiment, the system 102 may be configured to activate a subsequent workflow stage based on the updated candidate ranking. The subsequent workflow stage is determined by the dual-trigger evaluation. For example, the system 102 may be configured to orchestrate recruitment workflows, automate task routing, and trigger stage transitions based on system events or user actions.

In an embodiment, the system 102 may be configured to generate the ranked candidate list by parsing each canonical candidate document into a structured candidate profile comprising a plurality of profile fields. The system 102 may then perform encoding the structured candidate profile and the requisition data structure into corresponding vector representations. The system 102 may then perform computing the multi-dimensional match score based on the corresponding vector representations. The multi-dimensional match score corresponds to a plurality of matching dimensions.

In an embodiment, to compute the multi-dimensional match score, the system 102 may be configured to determine a skills dimension score based on a semantic similarity between skill indicators in the structured candidate profile and skill requirements in the requisition data structure. The system 102 may be configured to determine an experience dimension score based on an experience level indicated in the structured candidate profile relative to an experience requirement in the requisition data structure. The system 102 may be configured to determine a domain dimension score based on a domain alignment between the structured candidate profile and the requisition data structure. The system 102 may be configured to determine a location dimension score based on a geographic compatibility between a candidate location and a requisition location. The system 102 may be configured to compute the multi-dimensional match score based on an aggregation of the skills dimension score, the experience dimension score, the domain dimension score, and the location dimension score.

In an embodiment, for the dual-trigger evaluation, the system 102 may be configured to determine a satisfaction of a role-based trigger condition based on a detection of a predefined action associated with a specified role. The system 102 may be configured to determine a satisfaction of an event-based trigger condition based on a detection of a platform event. The platform event comprises at least one of an assessment score satisfying a threshold condition, an expiration of a time condition, or a receipt of an external event signal.

In an embodiment, the system 102 may be configured to identify a skills variance based on a comparison between a structured candidate profile and the requisition data structure. The system 102 may be configured to determine a gap representation based on a weighted difference between candidate skill attributes and target skill attributes derived from the requisition data structure. The weights for the weighted difference are derived from a market salience indicator. The system 102 may be configured to associate the gap representation with a learning module set based on a similarity between the gap representation and learning content metadata. Further, the system 102 may be configured to generate a personalized learning plan for a candidate based on the learning module set.

In an embodiment, to translate the workforce demand signal into the requisition data structure, the system 102 may be configured to determine an internal mobility candidate set based on a correlation between the requisition data structure and profile data associated with internal candidates. The system 102 may be configured to initiate an external sourcing action based on the requisition data structure. Further, the system 102 may be configured to generate a bridge upskilling output for at least one internal candidate based on a skills variance between the requisition data structure and profile attributes of the at least one internal candidate.

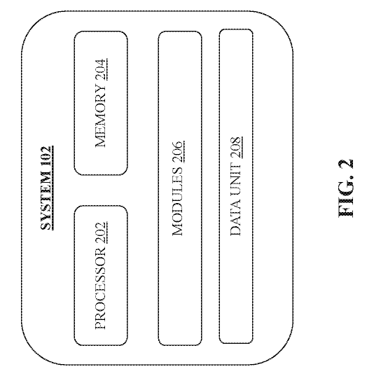

FIG. 2 illustrates a block diagram of components of the system 102, in accordance with an embodiment of the present disclosure.

In an embodiment, the system 102 may include at least a processor 202, a memory 204, a plurality of modules 206, and a data unit 208. The processor 202, the memory 204, the plurality of modules 206, and the data unit 208 are communicably coupled with each other.

In an embodiment, the at least one processor 202 may be in communication with the memory 204. The at least one processor 202 may be a single processing unit or several units, all of which could include multiple computing units. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions and data stored in the memory 204.

In an embodiment, the memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an embodiment, the plurality of modules 206 may include one or more sub‑modules, which, in coordination with the processor 202, enable the processor 202 to manage interactions, data exchange, and workflow execution across the talent lifecycle.

In some embodiments, the plurality of modules 206 may include a set of instructions that can be executed to cause the system 102 to perform any one or more of the methods disclosed. The system 102 may operate as a standalone device or may be connected, e.g., using a network, to other computer systems or peripheral devices. Further, while a single processing unit is illustrated, the term “processing unit” shall also be taken to include any collection of processing units implemented across the system 102 that individually or jointly execute a set, or multiple sets, of instructions to perform one or more computer functions.

In an embodiment, the plurality of modules 206 may be implemented using one or more artificial intelligence (AI) units that may include a plurality of neural network layers. Examples of neural networks include, but are not limited to, Convolutional Neural Network (CNN), Deep Neural Network (DNN), Recurrent Neural Network (RNN), and Restricted Boltzmann Machine (RBM). Further, ‘learning’ may be referred to in the disclosure as a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning. At least one of a plurality of CNN, DNN, RNN, RMB models and the like may be implemented to thereby achieve execution of the present subject matter’s mechanism through an AI model. A function associated with an AI unit may be performed through the non-volatile memory, the volatile memory, and the processor. The processor 202 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor, such as a neural processing unit (NPU). One or a plurality of processors control the processing of the input data in accordance with a predefined operating rule or artificial intelligence (AI) model stored in the non-volatile memory and the volatile memory. The predefined operating rule or artificial intelligence model is provided through training or learning.

In an embodiment, the data unit 208, amongst other things, includes routines, programs, objects, components, data structures, and the like, which perform tasks or implement data types. The data unit 208 may also be implemented as signal processor(s), state machine(s), logic circuitries, and/or any other device or component that manipulates signals based on operational instructions. Further, the data unit 208 may be implemented in hardware, instructions executed by a processing unit, or by a combination thereof. The processing unit may comprise a processor, such as the at least one processor 202, a state machine, a logic array, or any other suitable device capable of processing instructions. The processing unit may be a general-purpose processor that executes instructions to cause the general-purpose processor to perform the required tasks, or the processing unit can be dedicated to performing the required functions. In another embodiment of the present disclosure, the data unit 208 may be machine-readable instructions (software) that, when executed by the processor 202, perform any of the described functionalities.

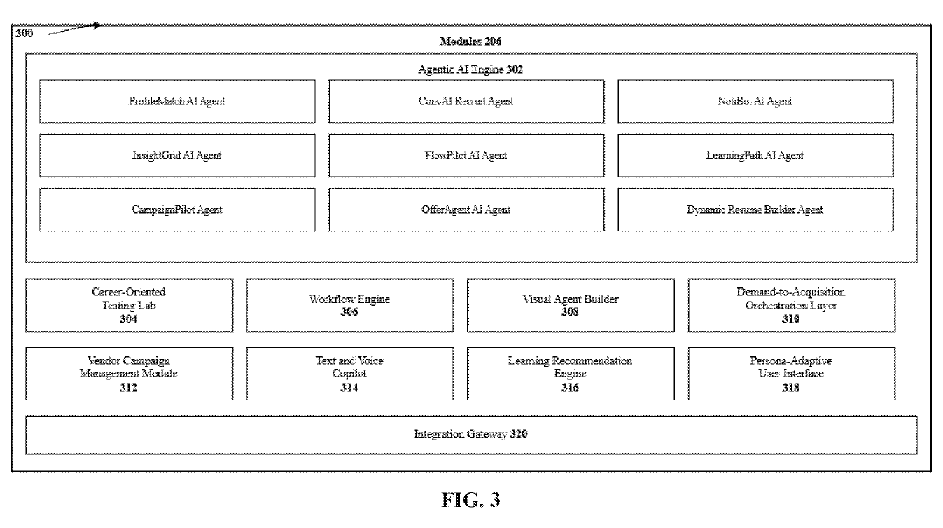

FIG. 3 illustrates a block diagram 300 of components of the modules 206 of FIG. 2, in accordance with an embodiment of the present disclosure. The modules 206 of the system 102 includes an agentic AI engine 302 that hosts a plurality of specialized AI agents.

In an embodiment, the agentic AI engine 302 functions as a core component that runs and manages a plurality of modular AI agents in the system 102. Each modular AI agent is configured to perform one or more pre-defined tasks autonomously. The agentic AI engine 302 is configured to automatically coordinate a communication between the modular AI agents through a publish-subscribe message bus, a shared blackboard memory, and a directed task graph defined by a visual agent builder 308.

In an embodiment, the agentic AI engine 302 implements an Agent Runtime comprising: (i) an agent registry storing each agent's identity, capabilities, a declared input schema, a declared output schema, a prompt template, tool bindings, and policy guards; (ii) a task scheduler that dispatches tasks to agents in a dependency order while enforcing rate limits, retries, time-outs, and idempotency keys; (iii) a context broker that assembles context windows for each agent invocation by composing candidate data, requisition data, prior agent outputs, and relevant knowledge-base passages; and (iv) an audit-and-explainability log that records, for every agent decision, an input context, a model identifier, a model version, a prompt, an output, a confidence score, and a rationale.

In an embodiment, the modules 206 of the system 102 includes a ProfileMatch AI Agent 304 configured to parse candidate profiles and rank candidates against role criteria using semantic and contextual analysis. The ProfileMatch AI Agent 304 is configured to parse candidate profiles, filter candidates based on pre-defined role criteria, and rank resumes using semantic and contextual analysis. The ProfileMatch AI Agent 304 thereby automatically matches resumes to jobs using semantic intelligence rather than mere keyword matching.

In an embodiment, the modules 206 of the system 102 includes a ConvAI Recruit Agent 306 configured to schedule, conduct, and evaluate AI-led interviews. When a candidate progresses to an “Initial Screening” stage, the ConvAI Recruit Agent 306 retrieves an interview blueprint from a workflow engine 324. The interview blueprint specifies competency areas (e.g., problem-solving, communication, role-fit), weights, timing, and follow-up branching logic. The ConvAI Recruit Agent 306 then conducts an interview through a text and voice copilot 332, scoring each response on competency rubrics, raising follow-up questions when responses are incomplete, and producing a consolidated transcript.

In an embodiment, the system 102 is configured to provide a text-and-voice copilot (e.g., copilot 332) that enables natural-language interaction with the agentic AI engine 302. The text-and-voice copilot receives a natural-language input expressed by a user via at least one of a text interface or a voice interface and processes the natural-language input to derive an intent representation corresponding to a requested operation. Based on the intent representation, the text-and-voice copilot generates an agent invocation request that identifies one or more agents of the agentic AI engine 302 suitable for performing the requested operation and supplies contextual data required for execution. The identified agent executes an action corresponding to the agent invocation request and produces an execution result, and the text-and-voice copilot generates and presents a context-aware response to the user based on the execution result, the response being formulated in natural language. In an embodiment, the text-and-voice copilot maintains a conversational context state across multiple interactions such that subsequent natural-language inputs are interpreted in view of prior inputs, previously executed actions, and stored contextual information associated with the user.

In an embodiment, the modules 206 of the system 102 includes a NotiBot AI Agent 308 configured to manage real-time notifications, reminders, and follow-ups. The NotiBot AI Agent 308 is configured to manage real-time communications including notifications, reminders, follow-ups, and interview status updates. The NotiBot AI Agent 308 dispatches communications across multiple channels including, without limitation, electronic mail, short message service (SMS), in-application notifications, push notifications, WhatsApp Business messaging, and integrated chat channels. The NotiBot AI Agent 308 further consolidates and rate-limits outbound notifications to avoid saturating recipients.

In an embodiment, the modules 206 of the system 102 includes an InsightGrid AI Agent 310 configured to provide labour-market insights, candidate-engagement analytics, and predictive hiring intelligence. The InsightGrid AI Agent 310 is configured to provide real-time labour market insights, candidate engagement trends, candidate behaviour analytics, and predictive hiring intelligence. The InsightGrid AI Agent 310 ingests platform telemetry, anonymised market signals, and external labour-market datasets, and generates dynamic dashboards for each persona. The InsightGrid AI Agent 310 produces, by way of non-limiting example: (a) a time-to-fill heatmap by skill family and geography; (b) a funnel-conversion view from sourced to applied to screened to interviewed to offered and then hired; (c) a source-of-hire attribution; (d) candidate engagement decay curves; (e) a bottleneck detection; and (f) predictive headcount forecasts based on growth trends, attrition history, and demand-pipeline analysis.

In an embodiment, the modules 206 of the system 102 includes a FlowPilot AI Agent 312 configured to orchestrate workflows and trigger stage transitions. The FlowPilot AI Agent 312 is configured to orchestrate recruitment workflows, automate task routing, and trigger stage transitions based on system events or user actions. The FlowPilot AI Agent 312 operates in concert with the workflow engine 324 and serves as a runtime interpreter of workflow definitions authored in the visual agent builder 326.

In an embodiment, workflow orchestration performed by the workflow engine 324 and the workflow-orchestration agent (e.g., FlowPilot AI Agent 312) implements a finite-state machine for each active candidate-requisition pair. Each transition of the finite-state machine is guarded by a Boolean combination of conditions including assessment scores, role actions performed by authorized users, timer expirations, and external events received from one or more external systems 106, such that stage advancement, rejection, rework, and escalation are performed according to configurable workflow logic.

In an embodiment, the modules 206 of the system 102 includes a LearningPath AI Agent 314 configured to recommend personalized learning resources, certifications, and videos. The LearningPath AI Agent 314 operates in conjunction with a learning recommendation engine 334 to compute a skill-gap analysis between a candidate profile and target role(s), and to compose an ordered learning plan.

In an embodiment, the modules 206 of the system 102 includes a CampaignPilot Agent 316 configured to launch and track sourcing campaigns. The CampaignPilot Agent 316 is configured to enable vendors or internal teams to launch, monitor, and optimize sourcing campaigns. The CampaignPilot Agent 316 supports campaign templates with target persona definitions, a channel mix (job boards, social, referral, email outreach, SMS), creative variants, a budget allocation, and conversion goals.

In an embodiment, the modules 206 of the system 102 includes an OfferAgent AI Agent 318 configured to generate offer letters based on candidate fit and historical compensation data. The OfferAgent AI Agent 318 retrieves compensation bands, internal-equity references, geography multipliers, and any localized statutory components (e.g., provident fund, gratuity, social security) to compose an offer package, then routes the offer package through the workflow engine 324 to appropriate approvers.

In an embodiment, the system 102 is configured to generate an offer data structure for a selected candidate through an offer agent (e.g., OfferAgent AI Agent 318) of the agentic AI engine 302. The offer agent determines components of the offer data structure based on a candidate fit score derived from prior evaluation stages and historical compensation data associated with comparable roles, organizational policies, and geographic parameters. Upon generation, the offer data structure is routed by the workflow engine 324 through an approval workflow defined within the system 102, wherein the approval workflow specifies one or more authorization steps associated with designated approval conditions. Following approval of the offer data structure, a workflow‑orchestration agent initiates execution of an onboarding workflow corresponding to the approved offer. As part of the onboarding workflow, a notification agent (e.g., NotiBot AI Agent 308) is triggered to dispatch onboarding notifications to the candidate, the onboarding notifications indicating required onboarding actions, associated timelines, and status information relevant to completion of onboarding activities.

In an embodiment, the modules 206 of the system 102 includes a Dynamic Resume Builder Agent 320 configured to generate role-aligned resumes for candidates. The Dynamic Resume Builder Agent 320 is configured to assist candidates (particularly students and early-career job-seekers) in creating role-aligned resumes by extracting relevant experience, projects, and skills from their profile, restructuring content per a target requisition, and applying readability heuristics. The Dynamic Resume Builder Agent 320 further supports auto-applying to recommended jobs using a curated resume.

In an embodiment, the modules 206 of the system 102 includes a Career-Oriented Testing Lab 322 configured to host and evaluate skill, behavioural, and code-simulation assessments. The modules 206 of the system 102 includes the workflow engine 324 configured to manage and execute configurable workflows tied to jobs, internships, onboarding, and campaigns. The modules 206 of the system 102 includes the visual agent builder 326 configured to provide a drag-and-drop, no-code interface for configuring the modular AI agents and associated workflows. The modules 206 of the system 102 includes a Demand-to-Acquisition Orchestration Layer 328 configured to translate a workforce demand into automated sourcing, upskilling, and mobility actions. The modules 206 of the system 102 includes a Vendor Campaign Management Module 330 configured to enable launch, monitoring, and optimization of sourcing campaigns. The modules 206 of the system 102 includes the text and voice copilot 332 configured to provide real-time, context-aware assistance through both text and voice modalities. The modules 206 of the system 102 includes the learning recommendation engine 334 configured to suggest personalized learning paths and content based on a skill-gap analysis. The modules 206 of the system 102 includes a Persona-Adaptive User Interface 336 configured to render role-specific views and dynamic forms. The modules 206 of the system 102 includes an Integration Gateway 338 configured to facilitate real-time and batch integration with external enterprise systems.

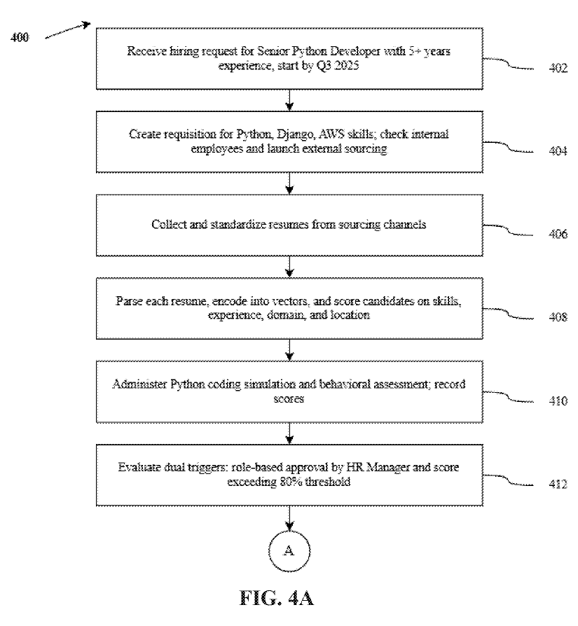

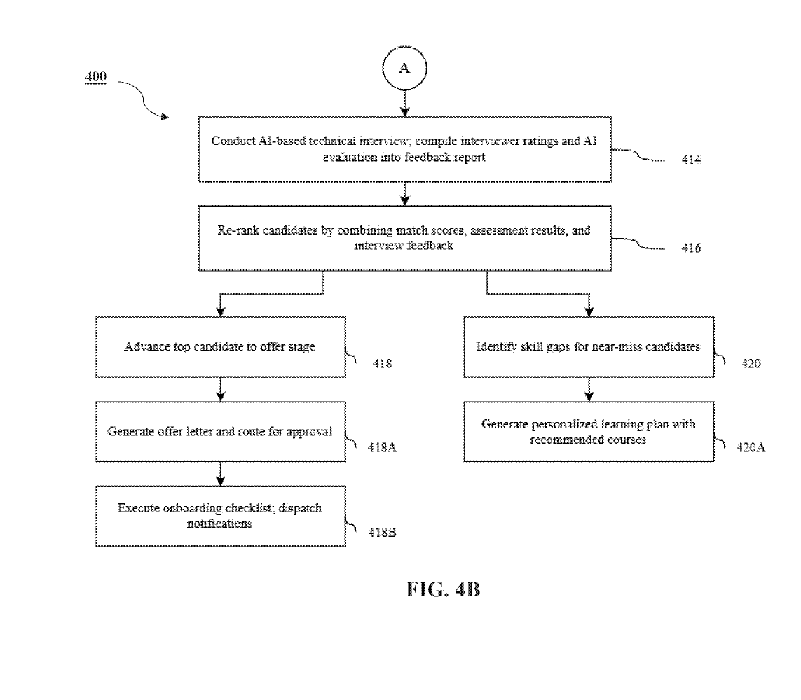

FIG. 4A-4B illustrates a flowchart depicting an exemplary operation of the system 102, in accordance with an embodiment of the present disclosure.

In an embodiment, the processor 202 may be configured to receive a hiring request at step 402. For example, a hiring request may be received for a Senior Python Developer with 5+ years experience and a Q3 2025 start date.

In an embodiment, the processor 202 may be configured to create a requisition at step 404. The requisition is created for specific skills such as Python, Django, and AWS skills. Internal employees are checked for potential matches and an external sourcing is launched.

In an embodiment, the processor 202 may be configured to collect and standardize resumes at step 406. Resumes are collected and standardized from sourcing channels.

In an embodiment, the processor 202 may be configured to parse and score candidates at step 408. Each resume is parsed, encoded into vectors, and candidates are scored across skills, experience, domain, and location dimensions. The processor 202 generates a ranked candidate list based on the plurality of canonical candidate documents and the requisition data structure.

In an embodiment, the processor 202 may be configured to administer assessments at step 410. A Python coding simulation and a behavioral assessment are administered and scores are recorded. The processor 202 generates an assessment outcome data structure by performing an assessment of a candidate from the ranked candidate list.

In an embodiment, the processor 202 may be configured to evaluate dual triggers at step 412. Dual triggers are evaluated including a role-based approval by an HR Manager and a score exceeding an 80% threshold. The processor 202 routes the assessment outcome data structure for workflow orchestration.

In an embodiment, the processor 202 may be configured to conduct an AI-based interview at step 414. An AI-based technical interview is conducted and interviewer ratings and an AI evaluation are compiled into a feedback report.

In an embodiment, the processor 202 may be configured to re-rank candidates at step 416. Candidates are re-ranked by combining match scores, assessment results, and interview feedback. The processor 202 generates the updated candidate ranking based on the multi-dimensional match score, the assessment outcome data structure, and the consolidated feedback data structure. The updated candidate ranking is associated with the evidence data structure and the gap data structure.

In an embodiment, the processor 202 may be configured to advance a top candidate to an offer stage at step 418. An offer letter is generated based on candidate fit and compensation data and routed for approval at step 418A. An onboarding checklist is executed and notifications are dispatched at step 418B.

In an embodiment, the processor 202 may be configured to identify skill gaps for near-miss candidates at step 420. Skill gaps are identified by comparing candidate profiles against the requisition. A personalized learning plan with recommended courses is generated at step 420A.

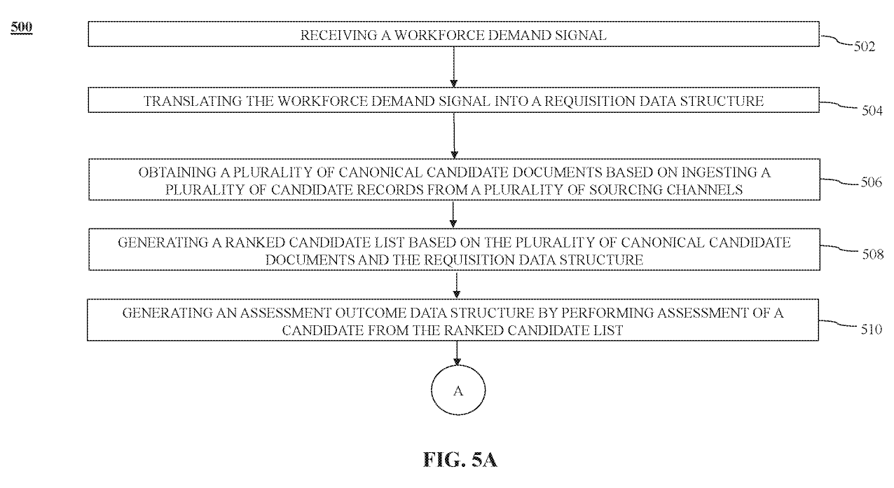

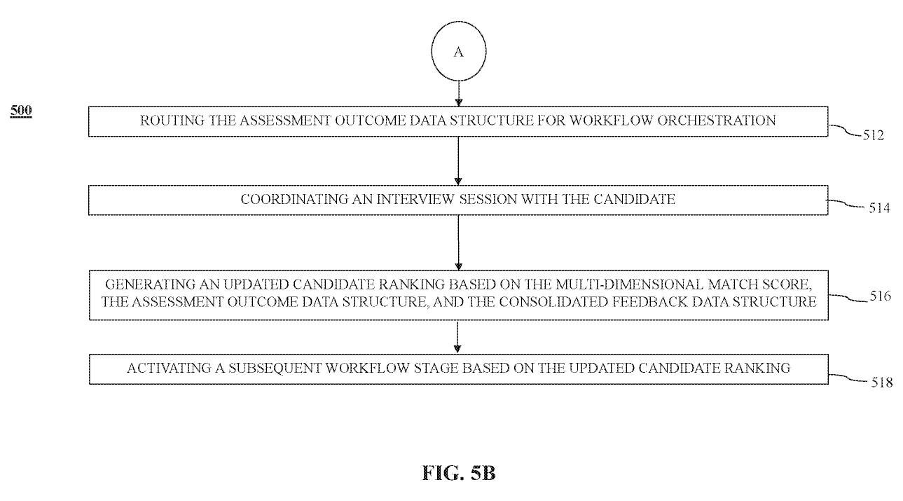

FIG. 5A-5B illustrate a flowchart of a method 500 for talent lifecycle management, in accordance with an embodiment of the present disclosure. The method 500 may be a computer-implemented method executed, for example, by the system 102. For the sake of brevity, constructional and operational features of the system 102 that are already explained in the description of FIG. 1-4 are not explained in detail in the description of FIG. 5A-5B.

At step 502, the method 500 may include receiving the workforce demand signal. The workforce demand signal indicates the talent requirement comprising the skill set specification and the timeline. In a non-limiting example, a business unit submits a demand for a specific number of engineers with specified skills and a target onboarding date through the demand-to-acquisition orchestration layer 328.

At step 504, the method 500 may include translating the workforce demand signal into the requisition data structure. The requisition data structure is associated with the skill set specification and the timeline. In a non-limiting example, the demand-to-acquisition orchestration layer 328 automatically creates requisitions with an appropriate workflow blueprint.

At step 506, the method 500 may include obtaining the plurality of canonical candidate documents based on ingesting the plurality of candidate records from the plurality of sourcing channels. In a non-limiting example, a multi-source talent aggregation pipeline ingests candidate records from job boards, vendor submissions, internal referrals, alumni databases, and professional networks, normalizing and deduplicating them into canonical candidate documents.

At step 508, the method 500 may include generating the ranked candidate list based on the plurality of canonical candidate documents and the requisition data structure. The generating produces the multi-dimensional match score, the evidence data structure, and the gap data structure for each candidate in the ranked candidate list. In a non-limiting example, the ProfileMatch AI agent 304 scores all candidates against the requisition and produces match scores with evidence and gap lists.

At step 510, the method 500 may include generating the assessment outcome data structure by performing an assessment of the candidate from the ranked candidate list. In a non-limiting example, the career-oriented testing lab 322 hosts coding tests and personality tests, and assessment scores are written to a candidate record.

At step 512, the method 500 may include routing the assessment outcome data structure for workflow orchestration. The routing triggers the stage transition based on the dual-trigger evaluation. The dual-trigger evaluation comprises the role-based trigger condition and the event-based trigger condition. In a non-limiting example, the FlowPilot AI agent 312 evaluates both role-based triggers (such as a hiring manager approval) and event-based triggers (such as an assessment score threshold) to determine stage transitions.

At step 514, the method 500 may include coordinating the interview session with the candidate. The coordinating comprises conducting the artificial-intelligence-based interview and generating the consolidated feedback data structure based on the interview session. In a non-limiting example, the ConvAI Recruit agent 306 conducts AI-led voice/text interviews against an interview blueprint and produces consolidated competency scores.

At step 516, the method 500 may include generating the updated candidate ranking based on the multi-dimensional match score, the assessment outcome data structure, and the consolidated feedback data structure. The updated candidate ranking is associated with the evidence data structure and the gap data structure. In a non-limiting example, candidates are re-ranked by combining match scores, assessment results, and interview feedback.

At step 518, the method 500 may include activating the subsequent workflow stage based on the updated candidate ranking. The subsequent workflow stage is determined by the dual-trigger evaluation. In a non-limiting example, top candidates are advanced to an offer stage while near-miss candidates are routed to a learning path generation.

In an embodiment, the method 500 comprises parsing each canonical candidate document into the structured candidate profile comprising the plurality of profile fields. In an embodiment, the method 500 comprises encoding the structured candidate profile and the requisition data structure into corresponding vector representations. In an embodiment, the method 500 comprises computing the multi-dimensional match score based on the corresponding vector representations, the multi-dimensional match score corresponding to a plurality of matching dimensions.

In an embodiment, the method 500 comprises determining the skills dimension score based on a semantic similarity between skill indicators in the structured candidate profile and skill requirements in the requisition data structure. In an embodiment, the method 500 comprises determining the experience dimension score based on an experience level indicated in the structured candidate profile relative to the experience requirement in the requisition data structure. In an embodiment, the method 500 comprises determining the domain dimension score based on the domain alignment between the structured candidate profile and the requisition data structure. In an embodiment, the method 500 comprises determining the location dimension score based on the geographic compatibility between the candidate location and the requisition location. In an embodiment, the method 500 comprises computing the multi-dimensional match score based on the aggregation of the skills dimension score, the experience dimension score, the domain dimension score, and the location dimension score.

In an embodiment, the method 500 comprises determining the satisfaction of the role-based trigger condition based on the detection of the predefined action associated with the specified role. In an embodiment, the method 500 comprises determining the satisfaction of the event-based trigger condition based on the detection of the platform event. The platform event comprises at least one of the assessment score satisfying the threshold condition, the expiration of the time condition, or the receipt of the external event signal.

In an embodiment, the method 500 comprises identifying the skills variance based on the comparison between the structured candidate profile and the requisition data structure. In an embodiment, the method 500 comprises determining the gap representation based on the weighted difference between candidate skill attributes and target skill attributes derived from the requisition data structure. The weights for the weighted difference are derived from the market salience indicator. In an embodiment, the method 500 comprises associating the gap representation with the learning module set based on the similarity between the gap representation and learning content metadata. In an embodiment, the method 500 comprises generating the personalized learning plan for the candidate based on the learning module set.

In an embodiment, the method 500 comprises determining the internal mobility candidate set based on the correlation between the requisition data structure and profile data associated with internal candidates. In an embodiment, the method 500 comprises initiating the external sourcing action based on the requisition data structure. In an embodiment, the method 500 comprises generating the bridge upskilling output for at least one internal candidate based on the skills variance between the requisition data structure and profile attributes of the at least one internal candidate.

Another embodiment of the present disclosure is a non-transitory computer-readable medium storing instructions that, when executed by a processor, cause the processor to: receive a workforce demand signal. The workforce demand signal indicates a talent requirement comprising a skill set specification and a timeline. The processor is configured to translate the workforce demand signal into a requisition data structure. The requisition data structure being associated with the skill set specification and the timeline. The processor is configured to obtain a plurality of canonical candidate documents based on ingesting a plurality of candidate records from a plurality of sourcing channels. The processor is configured to generate a ranked candidate list based on the plurality of canonical candidate documents and the requisition data structure. The generating produces a multi-dimensional match score, an evidence data structure, and a gap data structure for each candidate in the ranked candidate list. The processor is configured to generate an assessment outcome data structure by performing an assessment of a candidate from the ranked candidate list. The processor is configured to route the assessment outcome data structure for workflow orchestration. The routing triggers a stage transition based on a dual-trigger evaluation. The dual-trigger evaluation comprising a role-based trigger condition and an event-based trigger condition. The processor is configured to coordinate an interview session with the candidate. The coordinating comprises conducting an artificial-intelligence-based interview and generating a consolidated feedback data structure based on the interview session. Further, the processor is configured to generate an updated candidate ranking based on the multi-dimensional match score, the assessment outcome data structure, and the consolidated feedback data structure. The updated candidate ranking is associated with the evidence data structure and the gap data structure. The processor is configured to activate a subsequent workflow stage based on the updated candidate ranking. The subsequent workflow stage is determined by the dual-trigger evaluation.

The present disclosure provides the following advantages:
a) The present disclosure provides an agent-orchestrated automation that enables a configuration of AI agents for automating tasks such as resume screening, interview coordination, and candidate communications, thereby significantly reducing time-to-fill metrics and decreasing recruiter workload.
b) The present disclosure provides a no-code visual agent builder with a drag-and-drop interface that enables non-technical users to create and manage AI agents without coding knowledge, thereby empowering human resources and operations teams to adapt and automate workflows independently.
c) The present disclosure provides a unified talent lifecycle experience that manages internships, contract roles, and full-time positions on a single platform.
d) The present disclosure facilitates a career builder with a learning recommendation functionality that suggests personalized learning paths, certifications, and curated video content.
e) The present disclosure enables voice and text-based AI copilots that deliver contextual support and step-by-step guidance through multiple interface options, thereby creating a personalized assistance tailored for different user types including students, vendors, recruiters, and employers.
f) The present disclosure provides a dynamic workflow and process builder that allows organizations to customize pipelines, approval flows, document steps, and automation rules, thereby enabling real-time modifications without coding requirements or operational disruptions.
g) The present disclosure provides an integrated testing lab where skill assessments and behavioural simulations are built into a workflow, thereby allowing the AI agents to interpret results and recommend candidate next steps or job-role alignment automatically.
h) The present disclosure facilitates a demand-to-talent acquisition orchestration that allows business units or delivery teams to raise talent demands with required skill sets and timelines, thereby enabling AI agents to map these demands to appropriate sourcing pipelines, learning paths, and internal mobility suggestions.
i) The present disclosure enables a context-aware personalization where a user interface, data views, permissions, and suggestions adapt based on a user persona, thereby delivering relevant experiences for each role and enhancing clarity and engagement.
j) The present disclosure provides predictive insights and planning capabilities through built-in analytics that forecast headcount needs, hiring bottlenecks, and role-demand trends, thereby surfacing performance metrics in real time for data-driven decision-making.
k) The present disclosure facilitates plug-and-play integrations that connect to applicant tracking systems, customer relationship management platforms, video interview platforms, assessments, payroll, and onboarding systems, thereby streamlining a data flow across tools without custom development requirements.
l) The present disclosure enables time and cost efficiency by eliminating a need for multiple platforms and reducing repetitive tasks, thereby accelerating talent acquisition cycles and generating significant operational savings for organizations.
m) The present disclosure provides explainable autonomous recommendations with confidence scores and next-best actions, supporting reviewable, auditable decision-making and regulatory compliance.
n) The present disclosure facilitates a bidirectional synchronization with external ATS, Human Resource Management Systems (HRMS), ERP, CRM, LMS, and video platforms while remaining a complete native system of record across jobs, candidates, applications, interviews, and offers.

As would be apparent to a person in the art, various working modifications may be made to the method in order to implement the inventive concept as taught herein.

Moreover, the actions of any flow diagram need not be implemented in the order shown; nor do all the acts necessarily need to be performed. Also, those acts that are not dependent on other acts may be performed in parallel with the other acts.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, or essential feature or component of any or all the claims.

While specific language has been used to describe the subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A method for talent lifecycle management, the method comprising:
receiving a workforce demand signal, the workforce demand signal indicates a talent requirement comprising a skill set specification and a timeline;
translating the workforce demand signal into a requisition data structure, the requisition data structure being associated with the skill set specification and the timeline;
obtaining a plurality of canonical candidate documents based on ingesting a plurality of candidate records from a plurality of sourcing channels;
generating a ranked candidate list based on the plurality of canonical candidate documents and the requisition data structure, wherein the generating produces a multi-dimensional match score, an evidence data structure, and a gap data structure for each candidate in the ranked candidate list;
generating an assessment outcome data structure by performing assessment of a candidate from the ranked candidate list;
routing the assessment outcome data structure for workflow orchestration, wherein the routing triggers a stage transition based on a dual-trigger evaluation, the dual-trigger evaluation comprising a role-based trigger condition and an event-based trigger condition;
coordinating an interview session with the candidate, wherein the coordinating comprises conducting an artificial-intelligence-based interview and generating a consolidated feedback data structure based on the interview session;
generating an updated candidate ranking based on the multi-dimensional match score, the assessment outcome data structure, and the consolidated feedback data structure, wherein the candidate ranking is associated with the evidence data structure and the gap data structure; and
activating a subsequent workflow stage based on the updated candidate ranking, wherein the subsequent workflow stage is determined by the dual-trigger evaluation.

2. The method as claimed in claim 1, wherein the generating the ranked candidate list comprises:
parsing each canonical candidate document into a structured candidate profile comprising a plurality of profile fields;
encoding the structured candidate profile and the requisition data structure into corresponding vector representations; and
computing the multi-dimensional match score based on the corresponding vector representations, the multi-dimensional match score corresponding to a plurality of matching dimensions.

3. The method as claimed in claim 2, wherein the computing the multi-dimensional match score comprises:
determining a skills dimension score based on a semantic similarity between skill indicators in the structured candidate profile and skill requirements in the requisition data structure;
determining an experience dimension score based on an experience level indicated in the structured candidate profile relative to an experience requirement in the requisition data structure;
determining a domain dimension score based on a domain alignment between the structured candidate profile and the requisition data structure;
determining a location dimension score based on a geographic compatibility between a candidate location and a requisition location; and
computing the multi-dimensional match score based on aggregation of the skills dimension score, the experience dimension score, the domain dimension score, and the location dimension score.

4. The method as claimed in claim 1, wherein the dual-trigger evaluation comprises:
determining satisfaction of a role‑based trigger condition based on detection of a predefined action associated with a specified role; and
determining satisfaction of an event‑based trigger condition based on detection of a platform event, wherein the platform event comprises at least one of an assessment score satisfying a threshold condition, expiration of a time condition, or receipt of an external event signal.

5. The method as claimed in claim 1, further comprising:
identifying a skills variance based on comparison between a structured candidate profile and the requisition data structure;
determining a gap representation based on a weighted difference between candidate skill attributes and target skill attributes derived from the requisition data structure, wherein weights for the weighted difference are derived from a market salience indicator;
associating the gap representation with a learning module set based on similarity between the gap representation and learning content metadata; and
generating a personalized learning plan for the candidate based on the learning module set.

6. The method as claimed in claim 1, wherein the translating the workforce demand signal into the requisition data structure further comprises:
determining an internal mobility candidate set based on correlation between the requisition data structure and profile data associated with internal candidates;
initiating an external sourcing action based on the requisition data structure; and
generating a bridge upskilling output for at least one internal candidate based on a skills variance between the requisition data structure and profile attributes of the internal candidate.

7. A system for talent lifecycle management, comprising:
a processor;
a memory storing instructions that, when executed by the processor, cause the processor to:
receive a workforce demand signal, the workforce demand signal indicates a talent requirement comprising a skill set specification and a timeline;
translate the workforce demand signal into a requisition data structure, the requisition data structure being associated with the skill set specification and the timeline;
obtain a plurality of canonical candidate documents based on ingesting a plurality of candidate records from a plurality of sourcing channels;
generate a ranked candidate list based on the plurality of canonical candidate documents and the requisition data structure, wherein the generating produces a multi-dimensional match score, an evidence data structure, and a gap data structure for each candidate in the ranked candidate list;
generate an assessment outcome data structure by performing assessment of a candidate from the ranked candidate list;
route the assessment outcome data structure for workflow orchestration, wherein the routing triggers a stage transition based on a dual-trigger evaluation, the dual-trigger evaluation comprising a role-based trigger condition and an event-based trigger condition;
coordinate an interview session with the candidate, wherein the coordinating comprises conducting an artificial-intelligence-based interview and generating a consolidated feedback data structure based on the interview session;
generate an updated candidate ranking based on the multi-dimensional match score, the assessment outcome data structure, and the consolidated feedback data structure, wherein the candidate ranking is associated with the evidence data structure and the gap data structure; and
activate a subsequent workflow stage based on the updated candidate ranking, wherein the subsequent workflow stage is determined by the dual-trigger evaluation.

8. The system as claimed in claim 7, wherein to generate the ranked candidate list, the processor is configured to:
parsing each canonical candidate document into a structured candidate profile comprising a plurality of profile fields;
encoding the structured candidate profile and the requisition data structure into corresponding vector representations; and
computing the multi-dimensional match score based on the corresponding vector representations, the multi-dimensional match score corresponding to a plurality of matching dimensions.

9. The system as claimed in claim 8, wherein to compute the multi-dimensional match score, the processor is configured to:
determine a skills dimension score based on a semantic similarity between skill indicators in the structured candidate profile and skill requirements in the requisition data structure;
determine an experience dimension score based on an experience level indicated in the structured candidate profile relative to an experience requirement in the requisition data structure;
determine a domain dimension score based on a domain alignment between the structured candidate profile and the requisition data structure;
determine a location dimension score based on a geographic compatibility between a candidate location and a requisition location; and
compute the multi-dimensional match score based on aggregation of the skills dimension score, the experience dimension score, the domain dimension score, and the location dimension score.

10. The system as claimed in claim 7, wherein for the dual-trigger evaluation, the processor is configured to:
determine satisfaction of a role based trigger condition based on detection of a predefined action associated with a specified role; and
determine satisfaction of an event based trigger condition based on detection of a platform event, wherein the platform event comprises at least one of an assessment score satisfying a threshold condition, expiration of a time condition, or receipt of an external event signal.

11. The system as claimed in claim 7, the processor is configured to:
Identifying a skills variance based on comparison between a structured candidate profile and the requisition data structure;
determining a gap representation based on a weighted difference between candidate skill attributes and target skill attributes derived from the requisition data structure, wherein weights for the weighted difference are derived from a market salience indicator;
associating the gap representation with a learning module set based on similarity between the gap representation and learning content metadata; and
generating a personalized learning plan for the candidate based on the learning module set.

12. The system as claimed in claim 7, wherein to translate the workforce demand signal into the requisition data structure, the processor is configured to:
determine an internal mobility candidate set based on correlation between the requisition data structure and profile data associated with internal candidates;
initiate an external sourcing action based on the requisition data structure; and
generate a bridge upskilling output for at least one internal candidate based on a skills variance between the requisition data structure and profile attributes of the internal candidate.

13. A non-transitory computer-readable medium storing instructions that, when executed by a processor, cause the processor to:
receive a workforce demand signal, the workforce demand signal indicates a talent requirement comprising a skill set specification and a timeline;
translate the workforce demand signal into a requisition data structure, the requisition data structure being associated with the skill set specification and the timeline;
obtain a plurality of canonical candidate documents based on ingesting a plurality of candidate records from a plurality of sourcing channels;
generate a ranked candidate list based on the plurality of canonical candidate documents and the requisition data structure, wherein the generating produces a multi-dimensional match score, an evidence data structure, and a gap data structure for each candidate in the ranked candidate list;
generate an assessment outcome data structure by performing assessment of a candidate from the ranked candidate list;
route the assessment outcome data structure for workflow orchestration, wherein the routing triggers a stage transition based on a dual-trigger evaluation, the dual-trigger evaluation comprising a role-based trigger condition and an event-based trigger condition;
coordinate an interview session with the candidate, wherein the coordinating comprises conducting an artificial-intelligence-based interview and generating a consolidated feedback data structure based on the interview session;
generate an updated candidate ranking based on the multi-dimensional match score, the assessment outcome data structure, and the consolidated feedback data structure, wherein the candidate ranking is associated with the evidence data structure and the gap data structure; and
activate a subsequent workflow stage based on the updated candidate ranking, wherein the subsequent workflow stage is determined by the dual-trigger evaluation.
